(19) United States
(12) Patent Application Publication
(10) Pub. No.: US 2017/0071179 A1
(43) Pub. Date: Mar. 16, 2017

(54) COMPOUND ADJUSTABLE FISHING SINKER

(71) Applicant: Jimmy Morice Jamil, Warren, MI (US)

(72) Inventor: Jimmy Morice Jamil, Warren, MI (US)

(21) Appl. No.: 14/855,574

(22) Filed: Sep. 16, 2015

(51) Int. Cl. A01K 95/00; A01K 95/02

(52) U.S. Cl. CPC A01K 95/00; A01K 95/02

(57) ABSTRACT

A compound, adjustable fishing sinker comprised of a plurality of weights. All of the weights have a hole through which a fishing line may be tied, allowing any of the weights to be the initial weight put on a line. All of the weights have threaded screw shanks and threaded screw sockets, allowing the weights to be screwed together in any order, interchangeably. The system is designed to be durable and inexpensive. The weight elements, in aggregate, have a large enough mass to cause the hook to sink, but a small enough mass that they can be cast with the fishing line.

### FIELD OF INVENTION

This invention relates to the class, Fishing, trapping, and vermin destroying, and the sub-classes, line-attached hooks, bodies and rigs with adjustable weight or buoyancy. Specifically, this invention relates to an adjustable weight sinker designed to keep the bait floating at the correct depth.

### BACKGROUND OF INVENTION

The present invention is an improvement to the current state-of-the-art for fishing weights. Specifically, the current invention overcomes the main problem with the prior art, by allowing the user to add or subtract weight without un-tying the weight from the line. The current invention is cost-effective, and casts easily.

Fishing is a popular sport and recreation in the United States. Most fishers use a fishing pole with a fishing line attached. On the end of the fishing line, the fisher attaches a float, sinker, hook, and bait. The sinker is a weight that is tied to the fishing line. The fishing line is usually contained on a reel. The reel has a release button, which allows additional lengths of fishing line to come out. The fisher typically will cast the bait out into the water using a whip-like action with the pole while holding the release button. In order to effectively cast, the fishing line, float, sinker, hook, and bait must all be designed to fly through the air.

Since the float, sinker, and hook will all be in the water, they are all exposed to harsh environments. Additionally, due to repeatedly casting the line, there is a substantial likelihood that the float, weight and hook will eventually hit a rock, tree branch, or other hard obstacle. As a result, these parts are usually inexpensive, because they will need to be replaced quite often.

In order to catch a fish, the bait must float at the level or in the plane in which the fish is swimming. In order to get the bait to float at a particular level, the system of floats and sinkers are adjusted.

A float is a device which adds buoyancy in the system. A sinker is a weight element which decreases buoyancy in the system. To change the buoyancy of the system, the fisher must change the floats or sinkers. In a standard configuration, the float is closer to the pole, and further away from the hook, meaning that tying or untying the float is time consuming. As a result, in order to change the buoyancy level, the fisher will typically change the sinker.

Changing the sinker is, also, time-consuming, as it requires the fishing line to be untied and re-tied. In fishing competitions, or in fishing spots where the plane in the water in which the desired fish is swimming at is changing, the delay can be a burden. The market is looking for a cheap, durable sinker, that can be easily adjusted, in weight, while it is tied to the fishing line. Moreover, it has to be adjustable to both add and subtract weight while on a tied fishing line.

### PRIOR ART REVIEW

Many attempts have been made to create a weight or buoyancy system which is both quick and easy to use. U.S. Pat. No. 7,694,454, by named inventor Lumsden (“Lumsden 454”), is entitled, “In-line sliding fishing line release.” Lumsden 454 teaches an in-line, sliding line release for holding a sinker weight to a fishing line. The invention allows weight to be added and reduced without untying or cutting the fishing line. The sinker mount is comprised of a compression arm and rotational cam, which allows a pinching motion on the fishing line. The overall design is pretty complicated for the purpose, meaning that it will not cast well, and that it is, relatively speaking, expensive.

U.S. Pat. No. ,340,858, by named inventor Corbitt (“Corbitt '858”), is entitled, “Slip-on hydrodynamic symmetrical fishing sinker.” Corbitt '858 teaches a sinker which is aerodynamic while casting. Corbitt '858 further discloses an eyelet opening, through which the fishing line passes, which is biased to the closed position. The eyelet looks much like a clasp on a jewelry necklace. Again, this invention is relatively bulky, and would not cast well.

U.S. Pat. No. 6,862,837, by named inventor Ryder (“Ryder '837”), is entitled, Fishing accessory that can be a float or a sinker.” Ryder '837 teaches a method of changing the weight by allowing sand or water to be trapped in a chamber in the body, thus affecting the buoyancy of the unit. This unit is bulky, and being made out of plastic, would break easily if it were to hit a solid obstacle while casting.

U.S. Pat. No. 6,651,479, by named inventor Ratte (“Ratte '479”), is entitled, “Fishing sinker and method of making.” Ratte '479 teaches a symmetrical sinker, which is designed so as to not tangle or twist the fishing line. The sinker is held in place by a force fit. The user can remove the sinker by inserting a screwdriver and gently prying it apart. This invention would not remain secure through repeated casting, making it a bit of projectile risk.

U.S. Pat. No. 5,930,888, by named inventors Ball, et. al., (“Ball '888”), is entitled, “Device to hold, dispense and install slotted weights used with fishing line.” Ball '888 teaches a device to dispense weights onto a fishing line. The weights have a wedge-shaped opening. The unit crimps the weight onto the fishing line, one at a time. This invention is overly complex and bulky, meaning that it would not cast well and is, relatively, expensive.

U.S. Pat. No. 5,531,042, by named inventors Rinker, et. al., (“Rinker '042”), is entitled, “Fishing sinker having interchangeable weights.” Rinker '042 teaches a method for adding weights to a fishing sinker in discrete amounts. Rinker discloses a sinker weight being comprised, amongst other things, of a flexible sinker sleeve with an aperture (opening), a connector, and a sinker weight that is long with a head (e.g., a nail). The weights are interchangeable. This invention uses nails as weights. The sharpened end of the nail is free, meaning that it creates a hazard.

U.S. Pat. No. 4,361,976, by named inventor Svoma (“Svoma '976”), is entitled, “Fishing line sinker and mold for making same.” Svoma '976 discloses a combinable fishing weight comprised of small monolithic rectangles of metal that can be attached, on to another. On one short edge surface of each monolith is a wire loop that connects to the short edge at both ends. On the other short edge surface of each monolith is a feature that the wire can be threaded through. Afterwards, the wire is bent, to secure weights together. The invention it adjustable allowing for weights to be both removed and added. The finger crimping of the wire is an annoyance, and the weights will only last a couple of casts, because the wire will fatigue-fail relatively quickly.

U.S. Pat. 4,040,199, by named inventor Raptis (“Raptis '199”) is entitled, “Fishing line sinker assembly.” Raptis '199 discloses a heavy sinker, intended for deep sea fishing. Raptis '199 teaches largely cylindrical weights that can be attached and detached easily. The first weight has means of mounting a fishing line on one of its flat surfaces. In its other surface is a screw hole. The remainder of the weights have screws protruding from the center of one flat surface and a screw hole centered in the other flat surface, allowing weights to be added to the first weight, or to subsequent weights. The first weight includes protrusions of the curved surface of the cylinder, to prevent the weight from rolling when placed on the deck. Raptis '199 claims a substantial weight, and teaches individual weights ranging from 1 pound (453 grams) to 2 pounds (906 grams). The assembly of the weights can weigh as much as 4 pounds (1.812 kg).

U.S. Pat. No. 2,863,253, by named inventor Hettinger (“Hettinger '253”), is entitled, “Compound sinker for fishing lines.” Hettinger '253 teaches a compound sinker, having a plurality of equality sized weight elements. The weight elements are cylindrical. There is a screw hole centered on one of the flat circular surfaces. There is a threaded protrusion centered on the other flat circular surface. The threaded protrusion has two perpendicular flat faces, orthogonal to the flat circular surface of the weight, itself. An aperture extends through the flat faces. The centerline of the aperture is perpendicular to the flat faces. The weight elements are made from bronze or lead. Hettinger '253 would not be cheap to manufacture, because of the extensive machining required to make a protrusion with two flat faces, and screw threads extending between the flat faces. Additionally, such an arrangement has a substantial risk of being mis-threaded. With lead and bronze, a single mis-threading can ruin a screw and screw hole, because the metals are so soft. Last, Hettinger '253 teaches a compound sinker, in which the radius of each protrusion in each weight element is roughly half the radius of the weight element, itself. This wastes material, and is more expensive to machine than a smaller screw.

U.S. Pat. No. 549,332, by named inventor Sewell (“Sewell '332”), is entitled, “Fishing line sinker.” Sewell '332 teaches a sectional sinker that is a frusto-conical shape. The top section has an eyelet to attach it to the fishing line. All of the sections, including the top section, are fabricated with lead or bronze cast around a hard metal core. Except for the top section, all of the additional sections have a screw stem extending from the center of their smaller circular flat surface. All of the sections, including the top section, have a screw-threaded socket centered on the larger circular flat surface. Overmolding metal on metal is an expensive operation.

U.S. Pat. No. 77,774, by named inventor Smith (“Smith '774”), is entitled, “Line sinker.” Smith '774 discloses a sinker made up of several components. There is a component containing a long screw shaft. There is another component containing a socket with screw threads, into which the screw shaft fits. There are a plurality of discs with holes through their center. The fisher can add or remove weight from the sinker by adding or removing discs. This invention requires machining operation for each disc, plus a machining and fabricating operation for each of the screw-shaft-containing and threaded-socket containing components. The invention is relatively complex to both make and use.

What the market is searching for is a small, cheap sinker that can be tied to the line a single time, and then can have weight added or subtracted from it.

### SUMMARY OF THE INVENTION

The present invention is a system of compound adjustable fishing sinker, which contains a plurality of easily interchangeable, durable, inexpensive, and compact components. The system is comprised of a set of incremental weights. Each weight has at least two flat surfaces. In one flat surface is centered a threaded screw shank and in the other flat surface is centered a screw-threaded socket. Each top screw shank contains a through-hole aperture, which allows the weight to be tied to a fishing line. As a result, any of the weight elements in the compound adjustable fishing sinker can be tied to the fishing line. Once the first weight is tied to the line, each incremental weight can be added by screwing it on. When repeatedly casting, the user can, by touch, easily verify that the weights are still screwed together.

The compound adjustable fishing sinker is, in aggregate, typically, less than 100 grams or approximately four (4) ounces. The heaviest single weight element is 56 grams, or two (2) ounces. The present invention can be fabricated from any suitable metal, such as steel, lead, bronze or zinc. Steel, bronze, and lead all lend themselves to easy and cheap manufacture using lathes, CNC, screw machines, or a combination of the above. These metals do not need to be cast, as that would only increase the cost.

For steel parts, a suitable anti-corrosion coating would be added, such as powder coating, hexavalent chromium, chromium (III and IV), zinc plating (galvanizing), or a conversion coating.

### BRIEF DESCRIPTION OF THE DRAWINGS

There are thirteen (13) relevant drawings. FIG. 1 shows a side view of a first embodiment of a compound adjustable fishing sinker. FIG. 2 is an exploded side view of the first embodiment. FIG. 3 is top view of a single weight of the first embodiment. FIG. 4 is a bottom view of a single weight of the first embodiment.

FIG. 5 is a side view of a second embodiment of a compound adjustable fishing sinker. FIG. 6 is a side view of a first single element of the second embodiment. FIG. 7 is a side view of a second single element of the second embodiment. FIG. 8 is a side view of a third single element of the second embodiment.

FIG. 9 is a side view of a third embodiment of a compound adjustable fishing sinker. FIG. 10A is a side view of a first element of the third embodiment. FIG. 10B is a side view of a second element of the third embodiment. FIG. 11A is an isometric view of a first element of the third embodiment. FIG. 11B is an isometric view of a second element of the third embodiment.

### DETAILED DESCRIPTION OF THE PREFERRED EMBODIMENTS

The following description represents the inventor's current preferred embodiment. The description is not meant to limit the invention, but rather to illustrate its general principles of operation and construction. Examples are illustrated with the accompanying drawings.

FIG. 1 shows the side view of the first embodiment 100, with three frusto-conical weight elements 4, 5, 6, screwed together. The top-most weight element 4 has an exposed screw shank 1. The screw shank 1 has a continuous threaded screw groove 3. A through-hole eyelet 2 through the screw shank 1 allows the fishing line (not shown) to be attached to the top-most weight element 4.

From FIG. 2, is an exploded view of the first embodiment 100, with the top-most weight element 4, middle weight element 5, and bottom weight element 6, arranged about a centerline. Each weight element 4, 5, 6 of the first embodiment 100 has a top surface 14, 15, 16, a bottom surface 24, 25, 26, and a lateral surface 44, 45, 46 defined by a lateral edge 34, 35, 36. Each weight element 4, 5, 6, has an identical screw shank 1 with an eyelet 2 in the screw and a continuous screw thread 3. In the lower surface 14, 15, 16, of each weight element 4, 5, 6 is a screw receptacle 54, 55, 56. The screw shank 1 with continuous screw thread 3 threads or screws into the screw receptacle 54, 55, 56. The weight elements 4, 5, 6 can be screwed together by screwing the screw 1, 3 from one weight element 4, 5, 6 into the screw receptacle 54, 55, 56 of another weight element 4, 5, 6. The fishing line can be threaded through the eyelet 2 in the top-most weight 4. The eyelet 2 is integral to the screw shank 1, itself.

FIG. 3 shows a top view of a single weight element 6. The screw shank 1 is centered on the top surface 16 of the weight element 6. The lateral surface 46 meets the top surface 16. The screw has a slight taper, to assist with threading of the screw.

FIG. 4 shows the bottom view of a single weight element 6. The screw receptacle 56 is centered on the bottom surface 26. There is a slight taper 76 at the lip of the screw receptacle 56, to assist with threading the screw. The bottom surface 26 is defined by its perimeter edge 66.

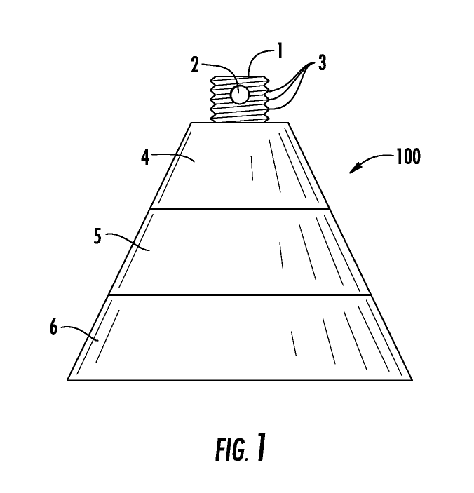

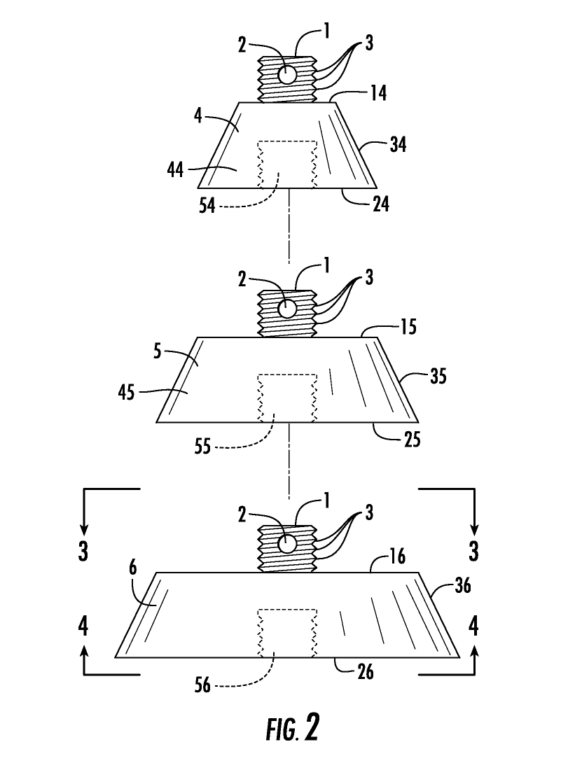

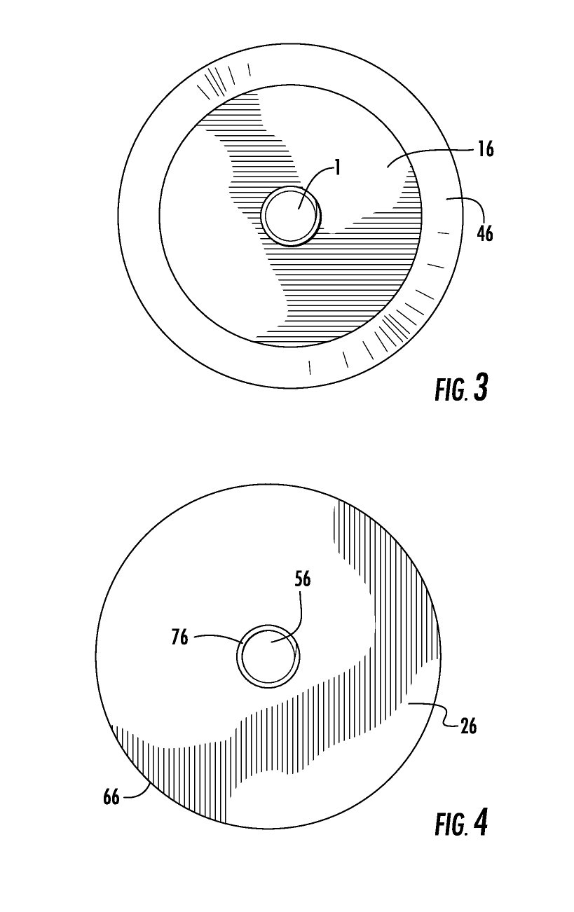

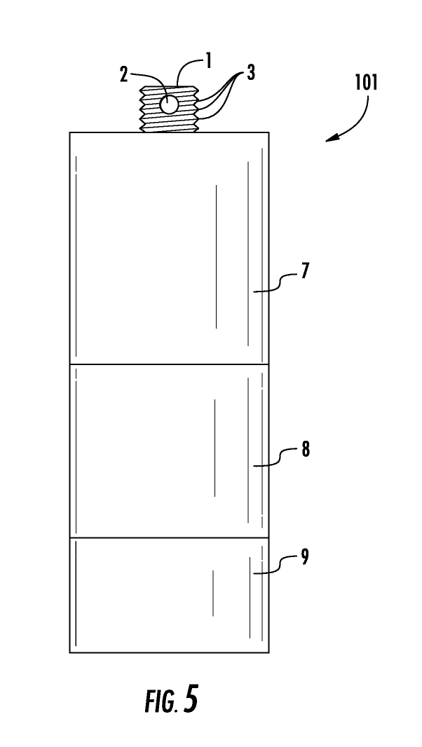

FIG. 5 shows the side view of the second embodiment 101 of the compound adjustable fishing sinker, with three cylindrical weight elements 7, 8, 9, screwed together. The top-most weight element 7 has an exposed screw shank 1. The screw shank 1 has a continuous threaded screw groove 3. A through-hole eyelet 2 through the screw shank 1 allows the fishing line (not shown) to be attached to the top-most weight element 7.

FIG. 6 is a lateral view of middle weight element 8 of the second embodiment 101 of the compound adjustable fishing sinker, shown in FIG. 5. The middle weight element 8 of the second embodiment 101 has a top surface 18, a bottom surface 28, and a lateral surface 48 defined by a lateral edge 38. The weight element 8 has a screw shank 1 with an eyelet 2 in the screw and a continuous screw thread 3. In the lower surface 18 of the weight element 8 is a screw receptacle 58. The fishing line (not shown) can be threaded through the eyelet 2 if the weight element 8 is the top-most weight element 8 of the second embodiment 101. The eyelet 2 is integral to the screw shank 1, itself.

FIG. 7 is a lateral view of top weight element 7 of the second embodiment 101 of the compound adjustable fishing sinker, shown in FIG. 5. The top weight element 7 of the second embodiment 101 has a top surface 17, a bottom surface 27, and a lateral surface 47 defined by a lateral edge 37. The weight element 7 has a screw shank 1 with an eyelet 2 in the screw and a continuous screw thread 3. In the lower surface 17 of the weight element 7 is a screw receptacle 57. The fishing line (not shown) can be threaded through the eyelet 2 if the weight element 8 is the top-most weight element 8 of the second embodiment 101. The eyelet 2 is integral to the screw shank 1, itself.

FIG. 8 is a lateral view of bottom weight element 9 of the second embodiment 101 of the compound adjustable fishing sinker, shown in FIG. 5. The top weight element 9 of the second embodiment 101 has a top surface 19, a bottom surface 29, and a lateral surface 49 defined by a lateral edge 39. The weight element 9 has a screw shank 1 with an eyelet 2 in the screw and a continuous screw thread 3. In the lower surface 19 of the weight element 9 is a screw receptacle 59. The fishing line (not shown) can be threaded through the eyelet 2 if the weight element 9 is the top-most weight element 9 of the second embodiment 101. The eyelet 2 is integral to the screw shank 1, itself.

The screw elements 1, 3 of FIGS. 6-8 can fit, interchangeably, into the screw receptacles 57, 58, 59, located in the lower surface 27, 28, 29, of the weight elements 7, 8, 9. The weight elements 7, 8, 9 can be added and subtracted simply by screwing them together or taking them apart. The lateral surface 47, 48, 49, of each weight element 7, 8, 9 can be textured to assist with gripping when the weight element 7, 8, 9 is wet. The screw 1, 3 and screw receptacles 57, 58, 59 are designed to remain together when they have been “finger tightened.” In other words, the screw 1, 3 and screw receptacles 57, 58, 59 are not load bearing, and they are designed to remain in contact when screwed together with low torque.

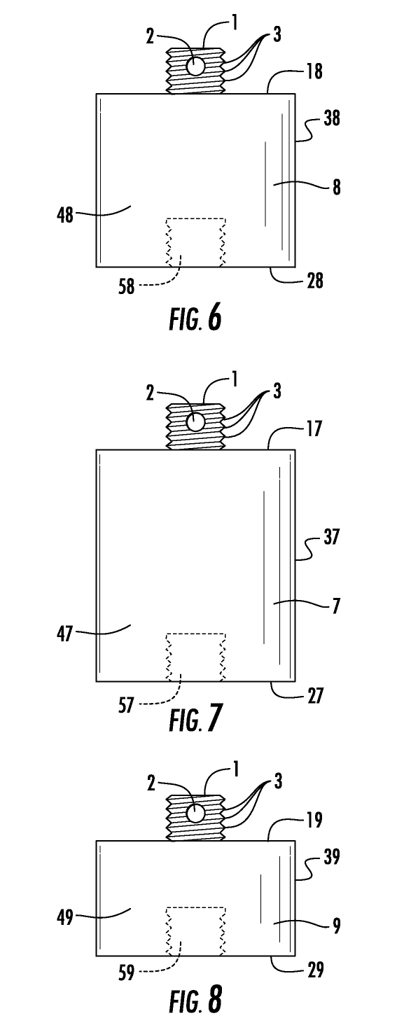

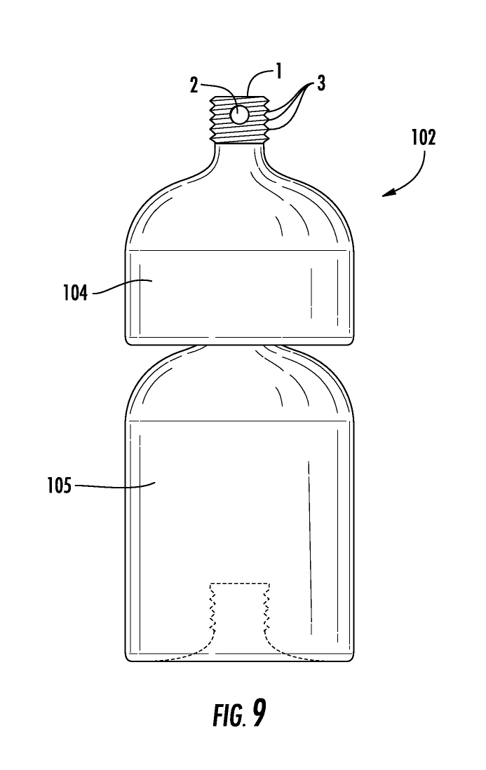

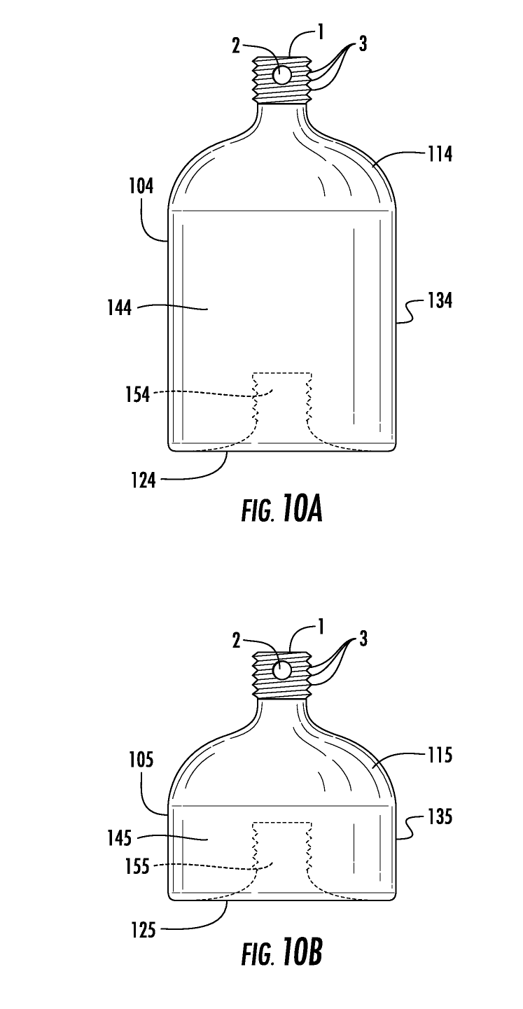

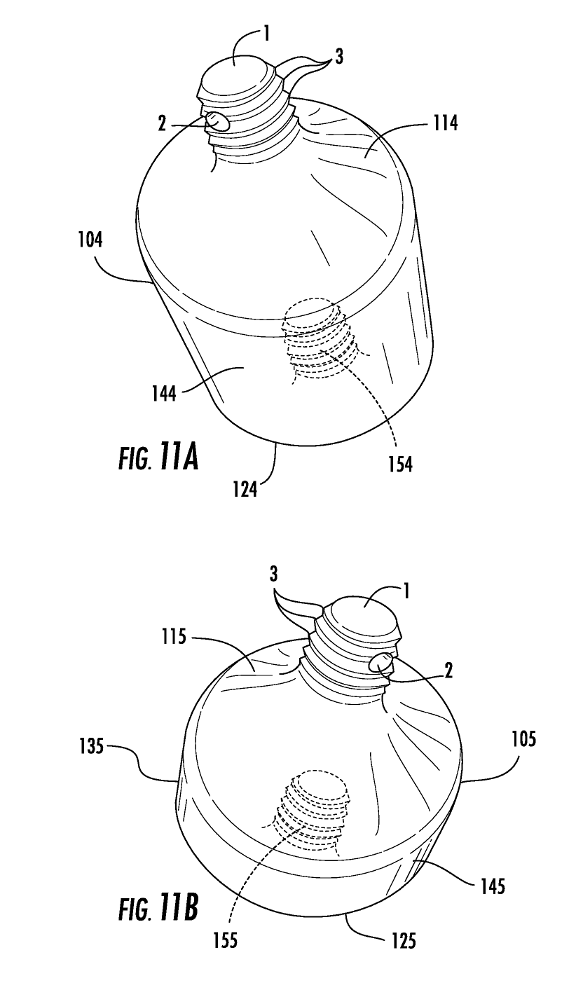

FIG. 9 shows a side view of the third embodiment 102 of the compound adjustable fishing sinker, with two dome-topped cylindrical weight elements 104, 105, screwed together. The top-most weight element 104 has an exposed screw shank 1. The screw shank 1 has a continuous threaded screw groove 3. A through-hole eyelet 2 through the screw shank 1 allows the fishing line (not shown) to be attached to the top-most weight element 104.

FIG. 10A and 10B show weight elements 104 and 105, respectively.

FIG. 10A is a lateral view of top weight element 104 of the third embodiment 102 of the compound adjustable fishing sinker, shown in FIG. 9. The top weight element 104 of the third embodiment 102 has a curved, dome-like, top surface 114, a bottom surface 124, and a lateral surface 144 defined by a lateral edge 134. The weight element 104 has a screw shank 1 with an eyelet 2 in the screw and a continuous screw thread 3. In the lower surface 124 of the weight element 104 is a screw receptacle 154. The fishing line (not shown) can be threaded through the eyelet 2 if the weight element 104 is the top-most weight element 104 of the third embodiment 102. The eyelet 2 is integral to the screw shank 1, itself.

FIG. 10B is a lateral view of bottom weight element 105 of the third embodiment 102 of the compound adjustable fishing sinker, shown in FIG. 9. The bottom weight element 105 of the third embodiment 102 has a curved, dome-like, top surface 115, a bottom surface 125, and a lateral surface 145 defined by a lateral edge 135. The weight element 105 has a screw shank 1 with an eyelet 2 in the screw and a continuous screw thread 3. In the lower surface 125 of the weight element 105 is a screw receptacle 155. The fishing line (not shown) can be threaded through the eyelet 2 if the weight element 105 is the top-most weight element 105 of the third embodiment 102. The eyelet 2 is integral to the screw shank 1, itself.

FIG. 11A and 11B show isometric views of weight elements 104 and 105, respectively. FIG. 11A is a lateral view of top weight element 104 of the third embodiment 102 of the compound adjustable fishing sinker, shown in FIG. 9. The top weight element 104 of the third embodiment 102 has a curved, dome-like, top surface 114, a bottom surface 124, and a lateral surface 144. The weight element 104 has a screw shank 1 with an eyelet 2 in the screw shank 1 and a continuous screw thread 3. In the lower surface 124 of the weight element 104 is a screw receptacle 154. The fishing line (not shown) can be threaded through the eyelet 2 if the weight element 104 is the top-most weight element 104 of the third embodiment 102. The eyelet 2 is integral to the screw shank 1, itself.

FIG. 11B is a lateral view of bottom weight element 105 of the third embodiment 102 of the compound adjustable fishing sinker, shown in FIG. 9. The bottom weight element 105 of the third embodiment 102 has a curved, dome-like, top surface 115, a bottom surface 125, and a lateral surface 145 defined by a lateral edge 135. The weight element 105 has a screw shank 1 with an eyelet 2 in the screw shank 1 and a continuous screw thread 3. In the lower surface 125 of the weight element 105 is a screw receptacle 155. The fishing line (not shown) can be threaded through the eyelet 2 if the weight element 105 is the top-most weight element 105 of the third embodiment 102. The eyelet 2 is integral to the screw shank 1, itself.

Each of the three embodiments 100, 101, 102 of the compound adjustable fishing sinker have weight elements 4, 5, 6, 7, 8, 9, 104, 105. Additional weight elements, similar to the shown weight elements 4, 5, 6, 7, 8, 9, 104, 105 can be used with each of the three embodiments 100, 101, 102.

The present invention, a compound adjustable fishing sinker, weighs less than 100 grams, when all weight elements are added together. In fact, for a three weight element embodiment, such as those shown in 100, 101, the weight is between 49-56 grams (1 ¾ounce-2 ounces) for all three weight elements 4, 5, 6, and 7, 8, 9. The largest weight elements 4, 7, 105 all weigh approximately 28 grams or 1 ounce. The medium weight element 5 for the first embodiment 100 weighs 14 grams or ½ ounce. The medium weight element 8 for the second embodiment weights 21 grams or ¾ ounce. The small weight 104 for the third embodiment 102 weighs 14 grams or ½ ounce. For each of the three embodiments 100, 101, 102, the respective weight is 49 grams (1 ¾ ounce), 56 grams (2 ounces) and 42 grams (1 ½ ounce).

The weight elements 4, 5, 6, 7, 8, 9, 104, 105 can be fabricated from any common metallic material, including steel, lead, zinc, tungsten, bronze, aluminum, or a combination of one or more of the above materials. All of the materials would lend themselves to screw-machine and lathing. Of course, steel is commonly used in screw machines and lathes as a material. Modern lathes and screw machines can turn lead shapes very quickly and easily, with high precision, because lead is softer than steel. For steel weight elements 4, 5, 6, 7, 8, 9, 104, 105, the top surface 14, 15, 16, 17, 18, 19, 114, 115, bottom surface 24, 25, 26, 27, 28, 29, 124, 125, lateral surfaces 44, 45, 46, 47, 48, 49, 144, 145, screw shank 1, 2, 3, and screw receptacle 54, 55, 56, 57, 58, 59, 154, 155, can all be corrosion coated, using powder coating, hexavalent chromium, chromium (III and IV), zinc plating, or a conversion coating.

The cylindrical weight elements 7, 8, 9, 104, 105 of the second 101 and third 102 embodiments are designed to have the sinker fall through the water smoothly. The frusto-conical shape of the first embodiment 100 will cause that sinker to undulate from side-to-side as it sinks.

I claim:

1. A compound, adjustable fishing sinker, comprised of a plurality of metallic weight elements, wherein each weight element, itself, weighs 56 grams or less; and
wherein all of the weight element, individually, have at least two flat circular surfaces; and at least one other surface extending, continuously between the two flat circular surfaces; wherein protruding orthogonally from one of the flat circular surfaces of each weight element is a threaded screw shank through which there is an aperture; and wherein, centered on the other flat circular surface of each weight element is a screw-threaded socket being sized to accept any of the threaded screw shanks from any of the other weight elements.

2. The compound, adjustable fishing sinker in claim 1, wherein the weight elements are frusto-conical in shape.

3. The compound, adjustable fishing sinker in claim 2, wherein the threaded screw shank of each weight element is orthogonally centered on the smaller of the two flat circular surfaces; and wherein the screw-threaded socket is centered on the larger of the two flat circular surfaces.

4. The compound, adjustable fishing sinker in claim 1, wherein the weight elements are cylindrical.

5. The compound, adjustable fishing sinker in claim 1, wherein at least one of the surfaces of the weight elements is textured, in order to facilitate gripping them when they are wet.

6. The compound, adjustable fishing sinker in claim 1, wherein the metallic weight elements are constructed from lead.

7. The compound, adjustable fishing sinker in claim 1, wherein the metallic weight elements are constructed from bronze.

8. The compound, adjustable fishing sinker in claim 1, wherein the metallic weight elements are constructed from steel.

9. The compound, adjustable fishing sinker in claim 8, wherein a corrosion coating is applied to the exposed steel of each weight element using one or more of powder coating, hexavalent chromium coating, chromium (III and IV) coating, zinc coating (galvanizing), or a conversion coating.

10. A compound, adjustable fishing sinker, comprised of a plurality of metallic weight elements, wherein each weight element, itself, weighs 56 grams or less; and
wherein all of the weight element, individually, have at least two non-flat surfaces; wherein protruding orthogonally from one of the non-flat surfaces of each weight element is a threaded screw shank through which there is an aperture; and wherein, centered on another non-flat surface of each weight element is a screw-threaded socket being sized to accept any of the threaded screw shanks from any of the other weight elements.

11. The compound, adjustable fishing sinker in claim 10, wherein each weight element has a cylindrical surface, a convex surface, and a concave surface.

12. The compound, adjustable fishing sinker in claim 11, wherein the convex surface and the concave surface of each weight elements are opposed to each other at opposite ends of the cylindrical surface.

13. The compound, adjustable fishing sinker in claim 12, wherein the convex surface has an apex; the threaded screw shank extends orthogonally from the apex of the convex surface; the concave surface has a point that extends furthest inside the cylindrical surface; and the screw-threaded socket is centered on the point at which the concave surface extends furthest into the cylindrical surface.

14. The compound, adjustable fishing sinker in claim 10, wherein at least one of the surfaces of the weight elements is textured, in order to facilitate gripping them when they are wet.

15. The compound, adjustable fishing sinker in claim 10, wherein the metallic weight elements are constructed from lead.

16. The compound, adjustable fishing sinker in claim 10, wherein the metallic weight elements are constructed from bronze.

17. The compound, adjustable fishing sinker in claim 10, wherein the metallic weight elements are constructed from steel.

18. The compound, adjustable fishing sinker in claim 17, wherein a corrosion coating is applied to the exposed steel of each weight element using one or more of powder coating, hexavalent chromium coating, chromium (III and IV) coating, zinc coating (galvanizing), or a conversion coating.
